(19) United States
(12) Patent Application Publication
(10) Pub. No.: US 2015/0276494 A1
(43) Pub. Date: Oct. 1, 2015

(54) HIGH TEMPERATURE SENSOR AND METHOD FOR PRODUCING A PROTECTIVE COVER FOR A HIGH TEMPERATURE SENSOR

(71) Applicant: TESONA GMBH & CO.KG, Hörselberg/Hainich (DE)

(72) Inventor: Heiko Lantzsch, Eisenach (DE)

(21) Appl. No.: 14/428,891

(22) PCT Filed: Sep. 16, 2013
(86) PCT No.: PCT/EP2013/069153

§ 371 Date: Mar. 17, 2015

(30) Foreign Application Priority Data
Sep. 17, 2012 (DE) 20 2012 103 534.0

(51) Int. Cl. G01K 1/12; C03B 17/04; B28B 5/00; B29C 51/08; B29C 51/42

(52) U.S. Cl. CPC G01K 1/12; B29C 51/08; B29C 51/42; B28B 5/00; C03B 17/04; B29K 2101/00

(57) ABSTRACT

The invention relates to a method for producing a protective cover for a high temperature sensor comprising a sensor element, a protective enveloping which at least partially surrounds the sensor element, and a protective cover which is fixed to the protective enveloping. Said protective cover is produced according to a deep-drawing method and/or the protective cover is produced by applying heat with subsequent fusion to at least one side and/or the protective cover is produced by closing the protective enveloping by means of a base stop, in particular by pressing and/or soldering, and/or the protective cover is produced by closing one side according to a shaping method, in particular tumbling, and/or a soldering method.

### CROSS REFERENCE TO RELATED APPLICATIONS

This application claims priority under 35 U.S.C. §119 to PCT Application Number PCT/EP2013/069153 filed Sep. 16, 2013 which claims priority to German patent document 20 2012 103 534.0, the entire contents of which are hereby incorporated by reference herein.

### BACKGROUND

High-temperature sensors are used, for example, to measure the temperature in exhaust pipes of gasoline engines or in furnaces. They may be suited to measure temperatures of greater than 500° C. Especially when used in the automobile field, e.g. in exhaust gas cleaning systems, high-temperature sensors of this kind are exposed to high thermal and mechanical (due to the vibrations of the engine) loads. The sensor element for measuring the temperature is, therefore, typically protected by a protective envelope, in particular a protective tube, e.g. of metal.

DE 10 2008 060 033 A1 discloses a temperature sensor having a thermocouple, which includes a sheathed fireproof cable including a sensor element attached to the cable end facing the sample medium and featuring electric connecting leads that run through a casing tube of the sheathed cable for connecting the sensor element to an electronic evaluation unit. It is proposed to provide a protective sleeve which comprises a one-piece front part, without any welding points. In addition, it is proposed to provide the protective sleeve with a curvature on its front side facing the sample medium.

WO 2010/063682 A1 discloses a temperature sensor having a thermocouple, which includes a sheathed fireproof cable including a sensor element attached to the cable end facing the sample medium. Electric connecting leads run through a metal tube of the sheathed cable for connecting the sensor element to an electronic evaluation unit. The disclosed temperature sensor is to be usable for temperatures up to 1200° C., and capable of sensing fast temperature changes. To this end, the sensor element consists of a thermo wire bead which protrudes from the sheathed cable and is received by a protective envelope that is attached to the end of the sheathed cable facing the sample medium. The protective envelope comprises a one-piece front part, without any welding points, and the sheathed cable is a flexible thin-walled metal tube with a small outer diameter, with the connecting leads running through the section thereof pointing away from the sample medium and creating the desired interface with an on-board electronic system. The attachment of the temperature sensor to the measuring point is realized by a special ring collar and a union nut.

A high-temperature sensor having a sensor element mounted in a protective tube is disclosed in EP 2 196 787 A2. To allow reliable measurements also in high-temperature environments, e.g. the exhaust gas system of a motor vehicle, the protective tube is surrounded by a reinforcement tube, the reinforcement tube is composed of material whose coefficient of thermal expansion is higher than that of the material from which the protective tube is formed. The reinforcement tube is fixedly connected to the protective tube in a first region of the protective tube, and an abutment element is also fixedly connected to the protective tube in a second region of the protective tube. The reinforcement tube, owing to its greater thermal expansion, comes into mechanical contact with the abutment element above a predefined temperature, whereby the high-temperature sensor is mechanically stabilized above this temperature. The space between the sensor element and the protective tube cap of EP 2 196 787 A2 is filled with a material having good heat-conducting properties. In this case, fine silicon powder may be used. The stabilizing mechanical contacting of the protective tube with the abutment element requires a minimum temperature, so that particularly directly in the starting phase, respectively, the non-high-performance operation the overall arrangement tends to vibrate which may put the reliability of the measuring arrangement at risk. The high-temperature sensor can be fixed in the exhaust gas system by means of a mounting pod.

### SUMMARY

The present invention relates to a method for producing a protective cap for a high temperature sensor comprising a sensor element, a protective envelope surrounding the sensor element at least partially, and a protective cap fixed to the protective envelope, as well as to a high-temperature sensor comprising a sensor element, a protective envelope, in particular a protective tube, surrounding the sensor element at least partially, and a protective cap fixed to the protective envelope.

Disclosed below is a developed method for producing a protective cap for a high-temperature sensor, and a high-temperature sensor comprising such a protective cap, such that the sensor element is protected even under great thermal, chemical and/or mechanical loads and can be manufactured cost-efficiently with little manufacturing expenditure.

Thus, it is possible to reliably fix the protective cap to the protective envelope in an easy manner. In particular, it may be possible to easily fix the protective cap to the protective envelope in a gas-proof manner so that the sensor element is protected against chemical and other influences.

In an embodiment of the invention it is provided that when the protective cap is produced in a deep-drawing process, the protective envelope serves as a drawing punch for the deep-drawing process, wherein the protective envelope is formed as a protective tube from a high-strength material, such as ceramic, glass ceramic and/or polymer ceramic.

In this embodiment of the invention the protective envelope may be sufficiently stable. The method may be carried out if the protective envelope is configured as a stable protective tube.

In another embodiment of the invention it is provided that the protective cap is produced from a workpiece made of a thin sheet.

With a thin sheet as work piece the deep-drawing process can be carried out efficiently and inexpensively.

In another embodiment of the invention it is provided that the workpiece is thermally conditioned prior to and/or during the performance of the deep-drawing process, by means of a gas burner, electromagnetic radiation, laser light and/or inductive heating.

A thermal conditioning, for example, a sufficient heating, facilitates the processing of the workpiece from which the protective cap is formed. Gas burners, electromagnetic radiation, laser light and/or inductive heating allow-a contactless conditioning of the workpiece.

In another embodiment of the invention it is provided that in the production by the introduction of heat, with a subsequent fusion, first a protective cap blank is placed on the protective envelope, and the protective cap blank is then fused by the introduction of heat and, thus, fixed to the protective envelope.

Fusing the protective cap blank allows a close and stable attachment of the protective cap on the protective envelope.

In another embodiment of the invention it is provided that the introduction of heat is accomplished by a gas burner, electromagnetic radiation, laser light and/or inductive heating. Thus, the melting point of the protective cap blank can be reached fast and accurately.

In another embodiment of the invention it is provided that first the heat is introduced into a protective cap blank, and then the protective cap blank is drawn onto the protective envelope in the deep-drawing process.

In another embodiment of the invention it is provided that in the production of the protective cap by closing the protective envelope with a bottom plug, this bottom plug is made of metal.

The use of metal permits a high stability along with a very good heat conductivity.

In another embodiment of the invention it is provided that the bottom plug is composed of a cylindrical casing element and a cover disc.

In another embodiment of the invention it is provided that in the production of the protective cap by closing one side by a forming process a protective cap blank is first placed on the protective envelope, in particular the protective tube, and the protective cap blank is then approximated to the contour of the protective envelope or the sensor element by applying a forming force.

The forming force may, in this case, be applied uniformly radially from all sides, or only from specific sides. Depending on the type of the applied forming force it is also possible that the protective tube is subjected to a deformation.

In another embodiment of the invention it is provided that the formed protective cap is subsequently connected, for example welded, to the protective envelope in a non-detachable manner.

The subsequent welding ensures that the protective cap is not detached from the protective envelope even under a strong load.

In another embodiment of the invention it is provided that the protective cap is mounted on the high-temperature sensor spaced apart from the sensor element.

The will be explained in more detail below by means of exemplary embodiments and with the aid of figures.

### BRIEF DESCRIPTION OF THE DRAWINGS

In the drawings:

FIG. 1a shows a cross-sectional view of a first high-temperature sensor;

FIG. 1b shows a second cross-sectional view of the high-temperature sensor of FIG. 1a;

FIG. 1c shows a first longitudinal view of the high-temperature sensor of FIG. 1a;

FIG. 1d shows a second longitudinal view of the high-temperature sensor of FIG. 1a;

FIG. 1e shows an enlarged view of a section of FIG. 1c;

FIG. 2a shows a cross-sectional view of a second high-temperature sensor;

FIG. 2b shows a second cross-sectional view of the high-temperature sensor of FIG. 2a;

FIG. 2c shows a first longitudinal view of the high-temperature sensor of FIG. 2a;

FIG. 2d shows a second longitudinal view of the high-temperature sensor of FIG. 2a;

FIG. 2e shows an enlarged view of a section of FIG. 2c;

FIG. 3a shows a cross-sectional view of a third high-temperature sensor;

FIG. 3b shows a second cross-sectional view of the high-temperature sensor of FIG. 3a;

FIG. 3c shows a first longitudinal view of the high-temperature sensor of FIG. 3a;

FIG. 3d shows a second longitudinal view of the high-temperature sensor of FIG. 3a;

FIG. 3e shows an enlarged view of a section of FIG. 3c;

FIG. 4a shows a cross-sectional view of a fourth high-temperature sensor;

FIG. 4b shows a second cross-sectional view of the high-temperature sensor of FIG. 4a;

FIG. 4c shows a first longitudinal view of the high-temperature sensor of FIG. 4a;

FIG. 4d shows a second longitudinal view of the high-temperature sensor of FIG. 4a;

FIG. 4e shows an enlarged view of a section of FIG. 4c;

FIG. 5a shows a cross-sectional view of a fifth high-temperature sensor;

FIG. 5b shows a second cross-sectional view of the high-temperature sensor of FIG. 5a;

FIG. 5c shows a first longitudinal view of the high-temperature sensor of FIG. 5a;

FIG. 5d shows a second longitudinal view of the high-temperature sensor of FIG. 5a; and

FIG. 5e shows an enlarged view of a section of FIG. 5c.

### DETAILED DESCRIPTION

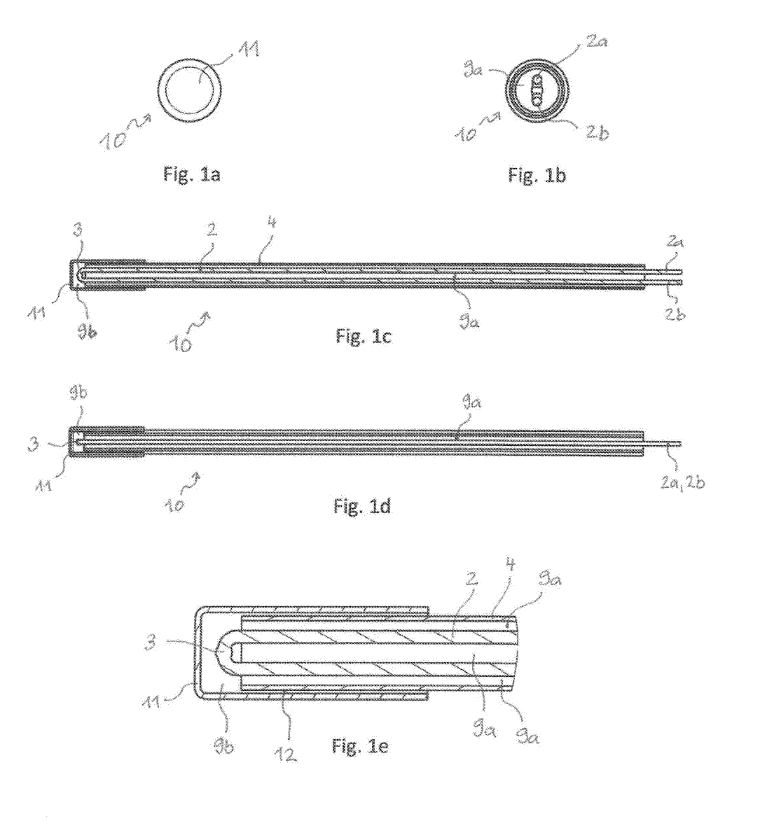

FIGS. 1a to 1d show a first high-temperature sensor 10 whose protective cap 11 was produced by a deep-drawing process. The high-temperature sensor 10 comprises a longitudinal sensor element 2 with a measuring section 3 arranged on the hot side of the high-temperature sensor 10. Two electrical connections 2a, 2b are located on the cold side.

The sensor element 2 is embedded in a filling material 9a, and is furthermore enclosed by a stable protective envelope 4. However, the measuring section 3 of the sensor element 2 projects out of the protective envelope 4 on the hot side. The measuring section 3 is embedded in a material 9b having good heat-conducting properties, and is covered by the protective cap 11. In a covered portion 12 the protective cap 11 grips over the protective envelope 4.

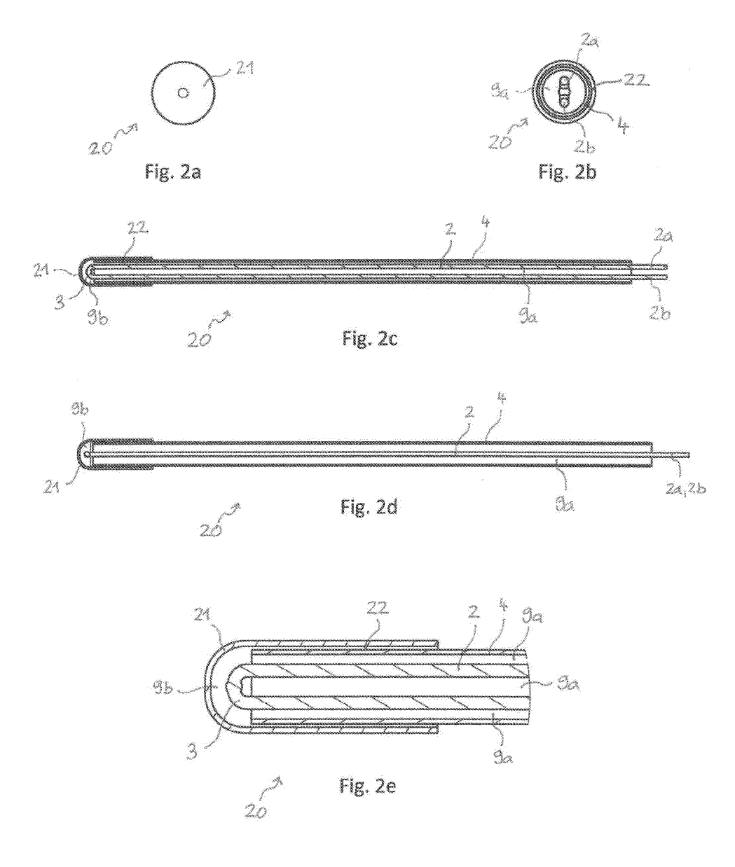

Elements of the high-temperature sensors shown in FIGS. 2a to 5e, which are designated with the same reference numbers used in FIGS. 1a to 1e, assume substantially the same functions as those of the high-temperature sensor shown in FIGS. 1a to 1e.

FIGS. 2a to 2e show lateral and longitudinal views of the high-temperature sensor 20 whose protective cap 21 was produced by the introduction of heat and subsequent fusion of at least one side. Fusing the protective cap 21 results in a stable, gas-proof closure between the protective cap 21 and the protective envelope 4.

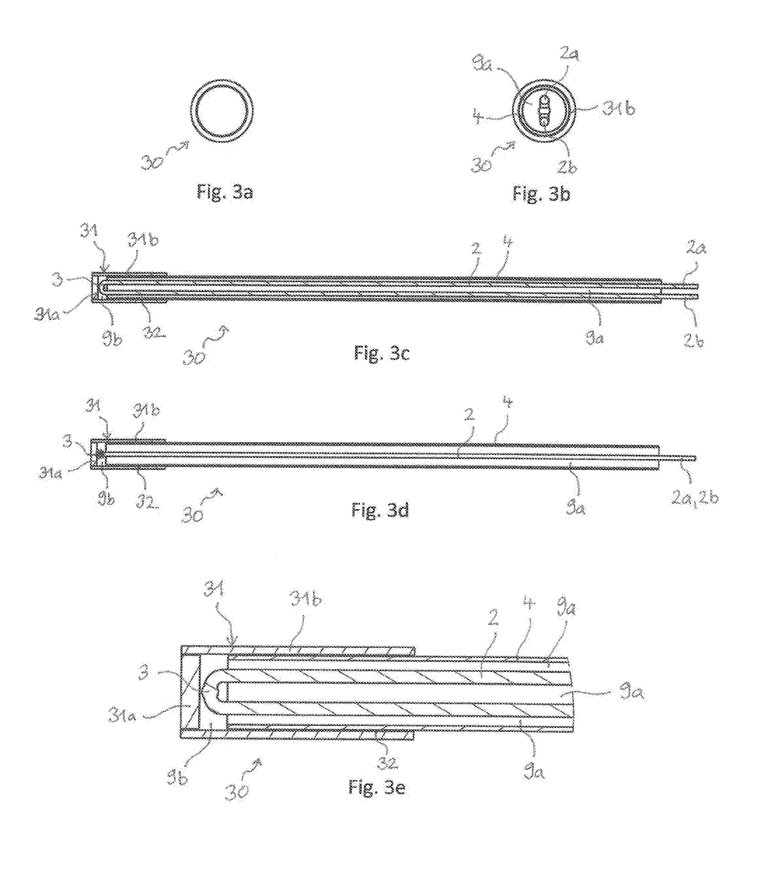

FIGS. 3a to 3e show lateral and longitudinal views of a high-temperature sensor 30 whose protective cap 31 was produced by closing the protective envelope by means of a bottom plug 31, for example by pressing and/or welding. The bottom plug 31 comprises a hollow-cylindrical section 31b which was pressed together with the protective envelope 4 in a section 32, and welded together subsequently. In other embodiments it is possible that only a pressing or only a welding takes place. The bottom plug 31 furthermore comprises a disc 31a which is located on the hot side of the high-temperature sensor 30.

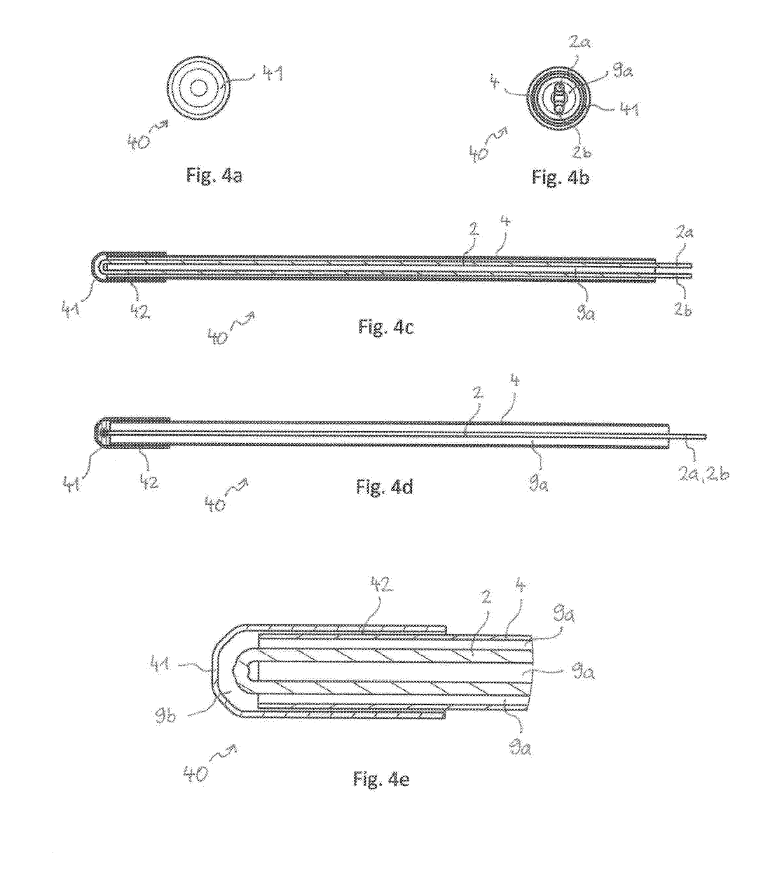

FIGS. 4a to 4e illustrate lateral and longitudinal views of a high-temperature sensor 40 whose protective cap 41 was fixed to the protective envelope 4 by wobbling and welding. The welding was, in this case, carried out in the welding region 42.

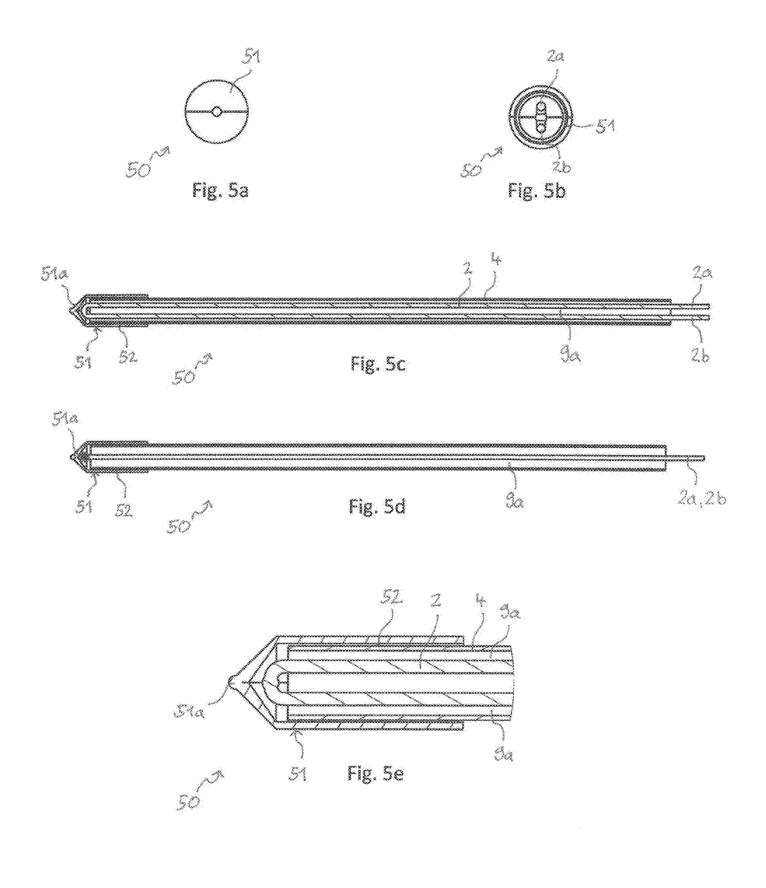

FIGS. 5a to 5e show lateral and longitudinal views of a high-temperature sensor 50 whose protective cap 51 was pressed, in a first section 51a, and welded to the protective envelope 4 in a second section 51b.

1. A method for producing a protective cap (11; 21; 31; 41; 51) for a high-temperature sensor (10) comprising:
a sensor element (2; 3),
a protective envelope (4) surrounding the sensor element (2; 3) at least partially, and
a protective cap (11; 21; 31; 41; 51) fixed to the protective envelope (4), wherein
the protective cap (11) is produced by a deep-drawing process, and/or
the protective cap (21) is produced by the introduction of heat, with subsequent fusion of at least one side of the protective cap (21), and/or
the protective cap (31) is produced by closing the protective envelope by means of a bottom plug (31) by pressing and/or welding, and/or
the protective cap (41) is produced by closing one side of the protective cap (41) by a wobbling and/or a welding process.

2. The method according to claim 1, characterized in that when the protective cap (11) is produced by the deep-drawing process, the protective envelope (4) serves as a drawing punch for the deep-drawing process, wherein the protective envelope (4) is formed from at least one of a a ceramic, a glass ceramic and a polymer ceramic.

3. The method according to claim 2, characterized in that the protective cap (11) is produced from a workpiece made of a thin sheet.

4. The method according to claim 3, characterized in that the workpiece is thermally conditioned prior to and/or during the performance of the deep-drawing process by means of at least one of a gas burner, electromagnetic radiation, laser light and inductive heating.

5. The method according to claim 1, characterized in that in the production of the protective cap by the introduction of heat, with the subsequent fusion, first a protective cap blank is placed on the protective envelope (4), and then the protective cap blank is fused by the introduction of heat and thus fixed to the protective envelope (4).

6. The method according to claim 5, characterized in that the introduction of heat is applied by a gas burner and/or by laser light.

7. The method according to claim 5, characterized in that the introduction of heat is accomplished by electric resistance heating by an electric current flowing through the protective cap blank.

8. The method according to claim 5, characterized in that first the introduction of heat is applied to a protective cap blank, and then the protective cap blank is drawn onto the protective envelope (4) in the deep-drawing process.

9. The method according to claim 1, characterized in that in the production of the protective cap (31) by closing the protective envelope (4) with the bottom plug (31), the bottom plug is made of a metal.

10. The method according to claim 9, characterized in that the bottom plug (31) is composed of a cylindrical casing element (31b) and a cover disc (31a).

11. The method according to claim 1, characterized in that in the production of the protective cap (41) by closing one side of the protective cap (41), a protective cap blank is first placed on the protective envelope (4) and then the protective cap blank is approximated to the contour of the protective envelope (4) or the sensor element (2) by applying a forming force.

12. The method according to claim 11 characterized in that the formed protective cap is subsequently connected to the protective envelope (4) in a non-detachable manner.

13. The method according to claim 1, characterized in that the protective cap is mounted on the high-temperature sensor (40) spaced apart from the sensor element (2).

14. A high-temperature sensor (10; 20; 30; 40; 50) comprising:
a sensor element (2),
a protective envelope (4) surrounding the sensor element (2) at least partially, and
a protective cap (11; 21; 31; 41; 51) fixed to the protective envelope, wherein,
the protective cap (11) is realized by a deep-drawing process, and/or
the protective cap (21) is produced by the introduction of heat, with subsequent fusion of one side of the protective cap (21), and/or
the protective cap (31) is a bottom plug pressed or welded to the protective envelope (4), and/or
the protective cap (41) is realized by closing one side of the protective cap (41) by a wobbling and/or a welding process.

15. The method according to claim 2, characterized in that the protective cap is mounted on the high-temperature sensor (40) spaced apart from the sensor element (2).

16. The method according to claim 3, characterized in that the protective cap is mounted on the high-temperature sensor (40) spaced apart from the sensor element (2).

17. The method according to claim 4, characterized in that the protective cap is mounted on the high-temperature sensor (40) spaced apart from the sensor element (2).

18. The method according to claim 5, characterized in that the protective cap is mounted on the high-temperature sensor (40) spaced apart from the sensor element (2).

19. The method according to claim 6, characterized in that the protective cap is mounted on the high-temperature sensor (40) spaced apart from the sensor element (2).

20. The method according to claim 10, characterized in that the protective cap is mounted on the high-temperature sensor (40) spaced apart from the sensor element (2).
